(19) United States
(12) Patent Application Publication
(10) Pub. No.: US 2013/0246143 A1
(43) Pub. Date: Sep. 19, 2013

(54) COMPETITIVE ON-LINE MARKETPLACE

(71) Applicant: Scott Eugene Hunt, Lewisville, TX (US)

(72) Inventor: Scott Eugene Hunt, Lewisville, TX (US)

(73) Assignee: Wizhunt Inc., Lewisville, TX (US)

(21) Appl. No.: 13/420,220

(22) Filed: Mar. 14, 2012

(51) Int. Cl. G06Q 30/00; G06Q 30/02

(52) U.S. Cl. 705/14.23; 705/26.62

(57) ABSTRACT

A method and data processing system provide a competitive marketplace via a network. The method includes identifying a plurality of items corresponding to a request for information about an item in responsive to receiving a request for information about the item. The method includes ranking the plurality of items according to price to form a ranking of the plurality of items. The method includes sending information about the plurality of items including the ranking for display on a display. According to the ranking, items with a lower price are displayed more prominently on the display than items with a higher price. Additionally, the method includes providing information regarding the ranking of at least one item in the plurality items to a seller of the at least one item.

### TECHNICAL FIELD

The present disclosure relates generally to buying and selling products and services over the internet and more specifically to systems and methods for searching and obtaining competitive pricing for products and services.

### BACKGROUND

Currently, online consumers searching to locate the lowest price on items, products and/or services have to search numerous websites and/or numerous results within a website in attempt to get the lowest or most competitive price on the product and/or service. The current online marketplace operates mainly based on posting and reposting advertisements and does not provide consumers time or cost efficiency within the shopping environment. Consumers attempting to get the lowest price for a product or service often have to search numerous websites and/or numerous results within a website. When consumers perform online shopping especially for big ticket items the consumer search is extensive, time consuming often yielding numerous results with little or no price fluctuation.

Accordingly, it would be advantageous to have systems and methods that take into account one or more of the issues discussed above as well as possibly other issues.

### SUMMARY

The different illustrative embodiments provide a method and data processing system for providing a competitive marketplace via a network.

In one embodiment, the method includes identifying a plurality of items corresponding to a request for information about an item in responsive to receiving a request for information about the item. The method includes ranking the plurality of items according to price to form a ranking of the plurality of items. The method includes sending information about the plurality of items including the ranking for display on a display. According to the ranking, items with a lower price are displayed more prominently on the display than items with a higher price. Additionally, the method includes providing information regarding the ranking of at least one item in the plurality items to a seller of the at least one item.

In another embodiment, a data processing system includes one or more storage devices configured to store program code and one or more processors configured to execute the program code. The data processing system is configured to identify a plurality of items corresponding to a request for information about an item in response to receipt of the request from another data processing system; rank the plurality of items according to price to form a ranking of the plurality of items; send information about the plurality of items including the ranking to the other data processing system for display on a display associated with the other data processing system, wherein, according to the ranking, items with a lower price are displayed more prominently on the display than items with a higher price; and provide information regarding the ranking of at least one item in the plurality items to a seller of the at least one item.

In yet another embodiment, a method includes, responsive to receiving a request for information about a vehicle from a first data processing system, identifying, by a second data processing system, a plurality of postal codes for an area having a radius equal to a distance included in the request. The distance is a distance from a location of a user associated with the first data processing system. The method includes determining whether one or more postal codes in the plurality of postal codes are not within a same state as the location of the user. The method includes, responsive to determining that one or more postal codes are not within a same state as the location of the user, excluding the one or more postal codes from the plurality of postal codes to form a reduced set of postal codes. The method includes identifying a plurality of vehicles corresponding to the request that are located at an address in the reduced set of postal codes. The method includes ranking the plurality of vehicles according to price to form a ranking. The method includes sending information about the plurality of vehicles including the ranking to the first data processing system for display on a display associated with the first data processing system. According to the ranking, vehicles with a lower price are displayed more prominently on the display than vehicles with a higher price. Additionally, the method includes providing, to a seller of one vehicle in the plurality of vehicles, information about one or more other vehicles in the plurality vehicles that have a price that is lower than the one vehicle of the seller including the price of the one or more other vehicles.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network of data processing systems in accordance with an illustrative embodiment;

FIG. 2 illustrates of a block diagram of a marketplace management system in accordance with an illustrative embodiment;

FIG. 3 illustrates of a view of a ranking of items in a set of search results displayed on a display of a client device in accordance with an illustrative embodiment;

FIG. 4 illustrates a process for providing a competitive marketplace over a network in accordance with an illustrative embodiment;

FIG. 5 illustrates a process for receiving offers for the sale of an item in a process for providing competitive marketplace in accordance with an illustrative embodiment;

FIG. 6 illustrates a process for searching for items according to postal code in a process for providing competitive marketplace in accordance with an illustrative embodiment;

FIG. 7 illustrates a process for managing sellers and seller identification information in connection with providing competitive marketplace in accordance with an illustrative embodiment;

FIG. 8 illustrates a process for handling a request to purchase an item in connection with providing competitive marketplace in accordance with an illustrative embodiment;

FIG. 9 illustrates a process for listing items at a price including a deposit in connection with providing competitive marketplace in accordance with an illustrative embodiment; and

FIG. 10 illustrates a data processing system in accordance with an illustrative embodiment.

### DETAILED DESCRIPTION

The various figures and embodiments used to describe the principles of the present invention in this patent document are by way of illustration only and should not be construed in any way to limit the scope of the invention. Those skilled in the art will understand that the principles of the invention may be implemented in any type of suitably arranged device or system.

The different illustrative embodiments of the present disclosure provide a number of different advantages over a traditional online marketplace. For example, the different illustrative embodiments utilize competitiveness amongst sellers as a foundational function principal to reduce prices and provide a competitive online market place for consumers. The various embodiments of the present disclosure deter and/or prevent the ability of price collaboration between sellers. The various embodiments empower sellers with the ability to determine their visibility of their products and/or services to consumers by their chosen prices.

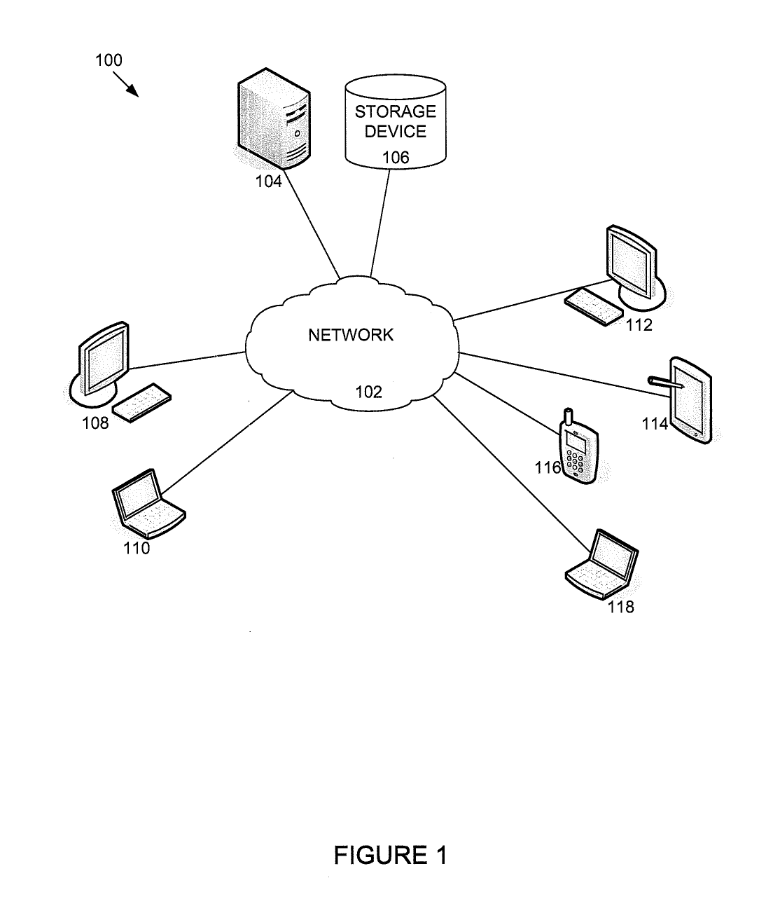

FIG. 1 illustrates an example networked system 100 of computing devices in which various systems and methods of the present disclosure can be implemented. As shown in FIG. 1, system 100 includes network 102, which is the medium used to provide communication links between various computers and other devices. Network 102 may include any suitable connections, such as wired, wireless, or fiber optic links. In some embodiments, network 102 represents at least a portion of the Internet and can include a worldwide collection of networks and gateways that use the Transmission Control Protocol/Internet Protocol suite of protocols to communicate with one another, although any other public and/or private network(s) could be used in system 100.

Elements of the present disclosure are implemented by server computer 104 and storage device 106 in connection with network 102. In this illustrative embodiment, server computer 104 in connection with storage device 106 provides computational resources for implementing an online market place via network 102. For example, server computer 104 may be a web based server for hosting a website for an online marketplace. Storage device 106 may include one or more databases storing and organizing information for products, services, sellers and consumers in connection with an online marketplace.

Client devices 108-118 also connect to network 102. Client devices 108-118 may be, for example, personal computers, network computers, personal digital assistants, tablet computers, mobile smart phones, or mobile computing devices. In this illustrative example, client devices 108 and 110 are data processing systems for sellers of products and services while client devices 112-118 are data processing systems for consumers of products and services in the online market place provided over network 102. Server computer 104 provides information, such as webpage documents and application data to client devices 112-118 as an interface to the online market place. In one example, separate interfaces are provided to seller data processing systems and consumer data processing systems via network 102.

Network data processing system 100 may include additional server computers, client devices, and other devices not shown. Network data processing system 100 also may be implemented as a number of different types of networks, such as, for example, the internet, a local area network (LAN), or a wide area network (WAN). FIG. 1 is intended as an example, and not as an architectural limitation for the different embodiments.

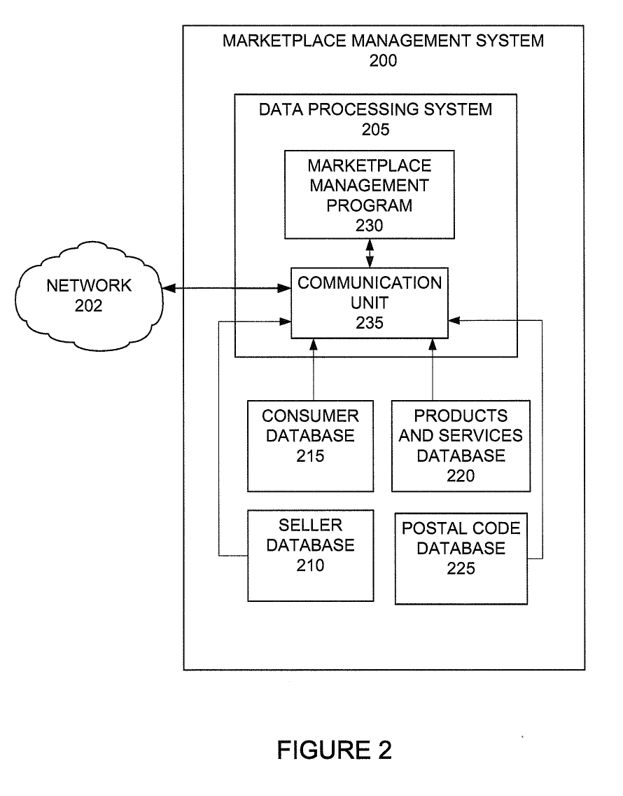

With reference now to FIG. 2, an illustration of a block diagram of a marketplace management system 200 is depicted in accordance with an illustrative embodiment. Marketplace management system 200 includes data processing system 205 in connection with a plurality of databases 210-225. In this illustrative example, data processing system 205 provides processing and software resources for implementing a marketplace accessible over network 202. For example, data processing system 205 may be a web server (e.g., server computer 104) that hosts a website for an online marketplace for products and services accessible over the internet by consumers (e.g., via client devices 112-118) and sellers (e.g., via client devices 108 or 110).

Marketplace management program 230 provides programming for data processing system 205 to implement the functionality of online marketplace within marketplace management system 200. Communication unit 235 provides data communication between data processing system 205 and other elements within marketplace management system 200. For example, communication unit 235 may retrieve information from databases 210-225. Communication unit 235 may also provide content to web browsers of consumers and sellers over network 202.

When a consumer requests to receive information about a product or service, the consumer logs on to a website provided by data processing system 205. Data processing system 205 identifies parameters in the consumer's request. For example, without limitation, the request may include parameters including price, color, model, availability, product name or identifier, and/or any other types of parameters for products and services that can be purchased. Data processing system 205 performs searches of various databases, (e.g., products and services database 220) both locally and over the internet to obtain information about a result set of items available for purchase that meet one or more of the parameters in the request. Data processing system 205 may perform any number of different searching algorithms and search any number of different databases in obtaining the information about the set of items that meet parameters in the request.

Upon identification of the result set, data processing system 205 ranks the items by price. Data processing system 205 then generates and formats information describing the set of items for display on the device of the consumer the request was received from. Data processing system 205 includes within the information the ranking for price to cause items having a more competitive price to be displayed more prominently on the display of the consumer's device than items having a less competitive price. For example, without limitation, items with lower prices may be displayed higher, with different colors, with bolding, with larger text, with highlighting, and/or any other way to draw attention to the items with lower prices as opposed to the items in the set with higher prices. For example, how and where an item in the result set is displayed back to the consumer may be referred to as page ranking or page positioning of the item. Thus, the consumer no longer has to search multiple sites or multiple searches within the site and can quickly view his/her wanted item by page ranking/positioning. For example, the lowest price within the consumer search may be the top ranked item on the result webpage.

As used herein, an item is a product or service. For example, this item may be a product or service that a seller intends to sell or that a consumer may intend to purchase. Marketplace management program 230 can be utilized to allow the consumers the ability to search by price of any product and/or service. For example, without limitation, marketplace management system 200 can be utilized in numerous markets and can be applied to searching and purchasing in housing, malpractice insurance, insurance, automobiles, healthcare insurance, physician visits, carpet cleaning, covered calls, bank loans, credit card offers, boats, electronics.

Marketplace management program 230 provides programming for data processing system 205 to contact (e.g., via communication unit 235) one or more sellers of items. For example, data processing system 205 may identify contact information for sellers via seller database 210 send messages (e.g., email, notification, text messages) to sellers.

In one example, the request from the consumer is a request to receive offers for the item from sellers of the item. For example, using marketplace management system 200, consumers can post interest in an item. In this example, data processing system 205 notifies all sellers of the request of the consumer to receive offers for the item. Thus, the result set of items returned to the consumer may be based on current seller offers for the item. This, offer procedure allows consumers to receive real-time current-market price offers and provides consumers with greater flexibility and options in obtaining competitive pricing for products and services.

In these illustrative embodiments, data processing system 205 notifies sellers of items in the results set of one or more prices of items for the seller to improve their page positioning. For example, data processing system 205 may identify a lowest priced item that is to be displayed most prominently on the consumer's display. Data processing system 205 may then send a message to sellers that do not currently have the lowest price to offer these sellers the opportunity to compete for the sale of their goods and services. In another example, data processing system 205 may notify a seller that a certain number of sellers have lower prices that the seller or that their offer ranks in at certain percentage of other offers. For example, the notification may be customized to each seller that has an item in the results set that meets the parameters of the consumer's request.

If data processing system 205 identifies or receives notification of more competitive pricing for item(s) in the results set, data processing system 205 re-ranks items in the results set according to the updated pricing. Data processing system 205 then provides information for this re-ranking to the consumer device to modify the page positioning of the items displayed to the consumer. For example, data processing system 205 may perform this re-ranking, and providing of information for the modification of the page positioning in real-time as the change in the price of the item(s) is identified. As used herein, real-time means performing some action at approximately the same time as another action is performed. For example, when an activity is performed in real-time by a data processing system delays due to processing and communication capabilities may occur.

In one non-limiting example, seller X's listing price for the item is $4,000 and seller Y's listing price for the exact same item is $5,000. In this situation seller X would have a more favorable page positioning on the website. If seller Y decides to reduce his/her price below $4,000 then the data processing system 205 will automatically reconfigure and place seller Y in a more favorable page position than seller X. This bidding for page positioning provides consumers with competitive pricing. This bidding for page positioning also adds benefits to sellers. Sellers can quickly be the gain more exposure for their products and services by reducing their price which in-turn provides them a more favorable page position which increases consumer access and view ability. More exposure will likely bring about more sales.

Data processing system 205 stores information about sellers and consumers in one or more databases (e.g., seller database 210, consumer database 215). For example, marketplace management program 230 may include programming for data processing system 205 to verify legitimate sellers and create an account for the sellers. Data processing system 205 may generate and provide an interface (e.g., webpage or application) for sellers to create an account and provide information about the products and services provided. Additionally, via an interface with a seller, data processing system 205 may provide and receive price notifications and changes as described above. Data processing system 205 may also provide an interface for consumers to create an account. Data processing system 205 may store information about consumer preferences, search history, items desired for purchase, seller ratings.

In some illustrative embodiments, data processing system 205 may rank and/or sort search results according to a seller's rating in addition to or instead of using ranking according to price. The seller's rating may be based on reviews, comments, and/or ratings from one or more consumers. In this example, if a consumer elects to search based on best ranked sellers and a seller with a lowest price may or may not be listed first in the page position depending on the rating of the seller relative to other seller's ratings.

In various embodiments, data processing system 205 may rank and/or sort search results according to proximity to a location of the users consumers. This ranking according to proximity may be utilized in addition to or instead of ranking according to price and/or seller rating. For example, a consumer may request to track the closest deals in proximity to their in addition to price. For example, data processing system 205 may first rank the results according to price, but the consumer can elect to include dealer/seller rating and distance (closest to farthest from consumer) in the ranking for the results.

In these illustrative embodiments, marketplace management system 200 provides mechanisms and safe guards to deter or otherwise attempt to prevent price collaboration by sellers. For example, when providing results to consumers, data processing system 205 may increase/decrease the price provided by the seller by a certain percentage and/or amount. In one example, the increase in price is for a deposit for the item, should the consumer choose to purchase the item. This deposit is paid to a third-party, (e.g., a provider of marketplace management system) and reduces a chance that fraudulent sellers from directly profiting from the consumers initial payment/deposit. This initial payment/deposit is payable to the third-party and is reflected/subtracted from the total price listed but does not reduce the amount the dealer initially listed. In another example, the price may be decreased to improve a ranking of the item relative to other items in the search results.

Additionally, because the deposit is paid to the third party, the contact information of the sellers and the buyer does not need to be reviled to either party. For example, a seller may list a vehicle for $50,000 while marketplace management system 200 lists the car at $50,500 to the consumer. When the consumer chooses to hold the item for purchase, the predetermined percentage, in this example 1%, (or amount $500) is paid listed as a deposit. After payment of the deposit, data processing system 205 provides availability of the sellers contact information. Upon payment of the deposit, data processing system 205 may send a message to the seller to ensure that the item is in stock and/or available. Based on availability of the item, the funds can be withdrawn or placed back into the consumer's account.

In various embodiments of the present disclosure, preventing the disclosure of seller contact information can deter price collaboration among sellers. For example, prior to the payment of the deposit, data processing system 205 may provide information that allows the sellers and consumers to view, for example, the item, the city the item is located is located in, and a seller's identification number but not names or direct contact such as a phone number and/or other information that would allow contact with the establishments.

Additionally, in these illustrative embodiments, data processing system 205 provides sellers with an identification number and periodically changes the identification number to add a layer of difficulty in price collaboration. For example, data processing system 205 may change the identification number after a predetermined period of time, at random intervals, per search session, or during search sessions. Data processing system 205 stores information about the seller to maintain track of the seller despite changing the identification number of the seller. For example, data processing system 205 may maintain a consumers rating of sellers even after periodically or randomly changing identification number.

In other embodiments, some or all of the seller's contact information may be displayed along with the seller's item in the search results returned to the consumer. For example, the dealer's name and/or location may be displayed along with the seller's identification number.

Upon receiving a request from a consumer to purchase an item, marketplace management system 200 may provide a wait period for other sellers to match or lower the price the consumer requested to purchase the item. For example, data processing system 205 may send notification of the intent to purchase the item to other sellers of the item and wait for offers or lower prices from the sellers before finalizing the purchase. In one non-limiting example, marketplace management system 200 allows a seller of a vehicle to offer to lower their price for their vehicle within a period of time. In this example, marketplace management system 200 may determine whether the offer matches the vehicle requested to be purchased by the consumer placed with the exception of the vehicle identification number (VIN).

In these illustrative embodiments, data processing system 205 can retrieves data from postal code database 235 in searching for items. Postal code database 235 includes postal codes compiled in the United States sorted by state. When receiving a request for information about an item, data processing system 205 can search for the item based on postal code, distance, and/or state where the item or seller is located. For example, in the United States some legislation may prevent dealers of automobiles from competing across state lines. In this example, it may be disadvantageous for a consumer to search by distance of their location because the area encompassing the distance from the consumer's location may include more than one state. This type of distance search does not provide all consumers the same opportunity to locate the lowest prices within their state. Not all states are round and not all of a state's population reside within the exact center of the state.

In these illustrative embodiments, data processing system 205 can search for the item by distance and postal code while confining the postal codes searched to locate the lowest most competitive price within a single state using postal code database 235. For example, postal code database 235 may store over 42,000 zip codes according to state. Data processing system 205 may run an algorithm to which locate the positioning of the search location in conjunction with the participating sellers of the item within a state based on the postal code of the seller and the consumer's requested search location. In one non-limiting example, this algorithm may calculate the search location based on the following equation: D=3958.75*(A tan(Sqrt(1−power(((Sin(@Lat1/57.2958)*Sin(lat2/57.2958))+(Cos(@Lat1/57.2958)*Cos(lat2/57.2958)*Cos((long/57.2958)−(@Long1/57.2958)))),2))/((Sin(@Lat1/57.2958)*Sin(lat157.2958))+(Cos(@Lat1/57.2958)*Cos(lat/57.2958)*Cos((long/57.2958)−(@Long1/57.2958)))))); where D is the distance between the location the consumer wants to search from and the location of the seller, lat1 and long 1 (latitude and longitude) are the location where the consumer wants to search from, and lat2 and long2 are the location of the seller. In another example, may utilize a third party service to determine the distance between two locations.

In these illustrative embodiments, marketplace management system 200 also provides consumers with the ability to directly and securely send credit information to sellers in an effort to get approval for financing. For example, data processing system 205 may send and receive a credit application to and from a consumer. Data processing system 205 may then a notification of the submission of the credit application to a seller. A financial manager from the seller may then access the credit application via the seller's interface provided by marketplace management system 200. Marketplace management system 200 also provides information and analytical tools to sellers for tracking the performance of the interne sales teams and/or individual members.

The illustration of marketplace management system in FIG. 2 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some embodiments functions performed in marketplace management system 200 may be performed by multiple data processing systems. For example, portions of the online marketplace described above may be implemented by different servers or implemented within client devices of sellers and consumers. Marketplace management program 230 may include program code for different functions that are performed within different locations within marketplace management system 200. In one example, the online marketplace may be implemented as a web application where portions of program code from marketplace management program are downloaded and installed on devices of sellers and consumers. Additionally, data processing system 205 may include one of more processors that execute program code from marketplace management program 230 to implement functions of data processing system 205 within marketplace management system 200.

In another example, in some embodiments, databases 215-225 may be arranged in a number of different configurations. For example, the databases 215-225 may be a single database stored in a storage device within data processing system 205 or may be stored externally to marketplace management system 200 and connected to data processing system 205 via network 202. In other examples, individual databases in databases 215-225 may be split among one or more storage devices with some information from databases 215-225 stored locally and other information stored remotely. In another example, resources within marketplace management system 200 (e.g., data processing system 205, databases 215-225) may be implemented in a cloud computing environment where operations and functionality of marketplace management system 200 is performed at one or more remote locations and delivered to sellers and consumers via network 202.

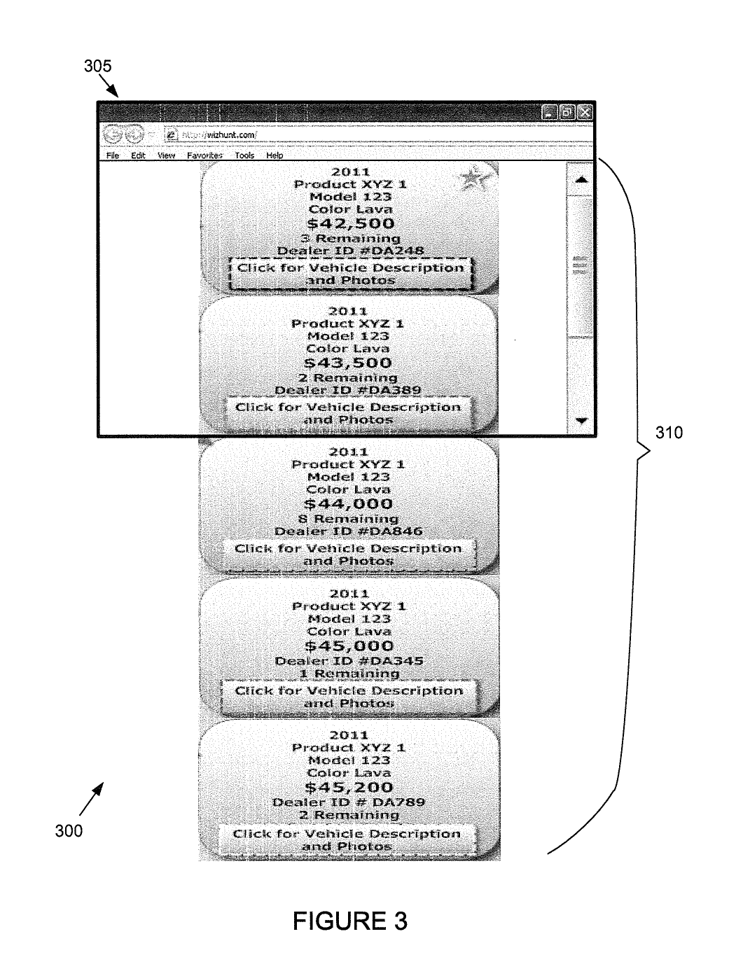

With reference now to FIG. 3, an illustration of a ranking of items in a set of search results displayed on a display of a client device is depicted in accordance with an illustrative embodiment. In this illustrative example, interface 300 is displayed on display 305. For example, interface 300 may be a graphical user interface formatted for display via a web browser on a display device of a client device (e.g., client devices 112-118).

In this illustrative example, interface 300 includes list of items 310 that are ranked according to price. As discussed above, items with more competitive prices are displayed more prominently or have better page positioning on the display of the client device. In this depicted example, lower priced items are placed before higher priced items in list of items 310. For example, as depicted, a consumer viewing list of items 310 would have to scroll down to see some of the higher priced items list of items 310. Also in this depicted example, the lowest price item is stared indicating that the item currently has the most competitive pricing. Should one of the prices for an item in the list improve, data processing system 205 will re-rank the items for display in accordance with the updated pricing. For example, the seller associated with Dealer ID #DA345 may lower their price from $45,000 to $42,000 to improve their page positioning from fourth to first in list of items 310.

The illustration of marketplace management system in FIG. 2 is intended as an illustrative example and not meant to imply physical or architectural limitations to the manner in which different illustrative embodiments may be implemented. For example, without limitation, the page positioning of items in list of items may include items with lower prices displayed higher, with different colors, with bolding, with larger text, with highlighting, and/or any other way to draw attention to the items with lower prices as opposed to the items with higher prices.

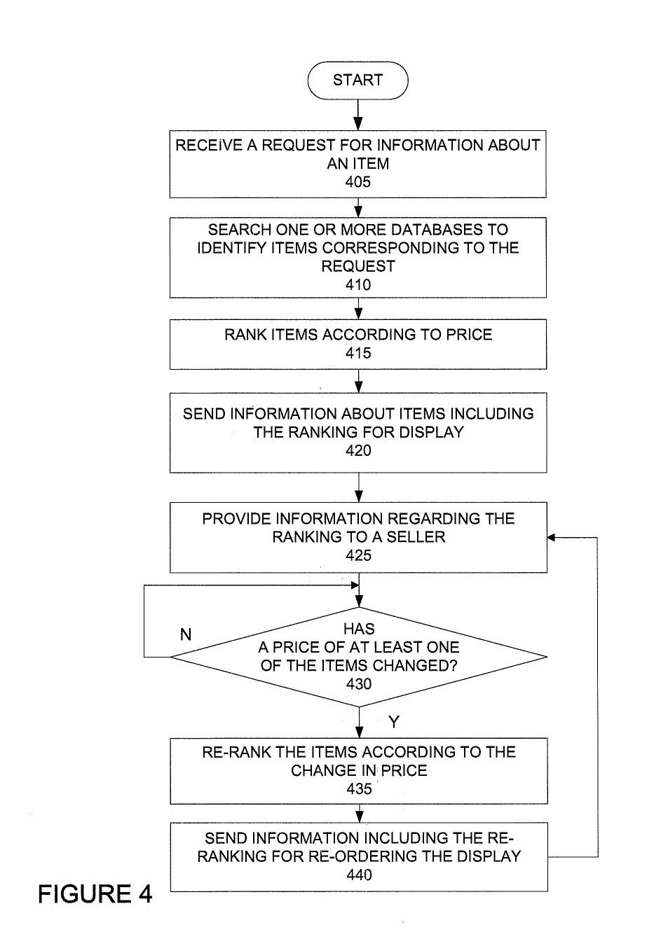

With reference now to FIG. 4, an illustration of a flowchart of a process for providing a competitive marketplace over a network is depicted in accordance with an illustrative embodiment. The process illustrated in FIG. 4 may be implemented in server computer 104 via network 102 in FIG. 1. The process also may be implemented by marketplace management program 230 in data processing system 205 in FIG. 2.

The process begins by receiving a request for information about an item (block 405). In block 405, the request may be a request from a consumer to search for products and services for sale by sellers. The process then searches one or more databases to identify items corresponding to the request (block 410). Thereafter, the process ranks items according to price (block 415).

The process then sends information about items including the ranking for display (block 420). In block 420, according to the ranking, items with a lower price are displayed more prominently on than items with a higher price. For example, the results of the search are displayed on a consumer's device such that lower priced items are displayed in a manner that that can be viewed easier than items with higher prices.

Thereafter, the process provides information regarding the ranking to a seller (block 425). In block 425, the process may provide information about one or more items in the result set that have a price that is lower than an item of this seller and include the price of the one or more items. For example, the process may provide a seller with a report of where the seller's products and services have ranked in multiple search results over a period of time. In response to this information about the seller's page positioning, the seller may choose to lower their price to improve their page positioning.

The process then identifies a change in price of at least one of the items (block 430). In block 430, in one example, the seller may notify marketplace management system 200 of the change in their price to obtain better page positioning. In another example, marketplace management system 200 may periodically search for updated pricing on items in the results set. When the process identifies a change in price of at least one of the items, the process re-ranks the items according to the change in price (block 435). Thereafter, the process sends information including the re-ranking for re-ordering the display (block 440). In blocks 435 and 440, the re-ranking of the items and sending of the information to modify the page positioning on the consumer device is performed in real-time as the change in price is identified. For example, the client device may periodically refresh the webpage to receive updated page positioning information. In another example, the webpage may be dynamically updated with the updated page positioning information. The process then returns to block 425 and provides information regarding the re-ranking to a seller and continues to monitor for changed prices.

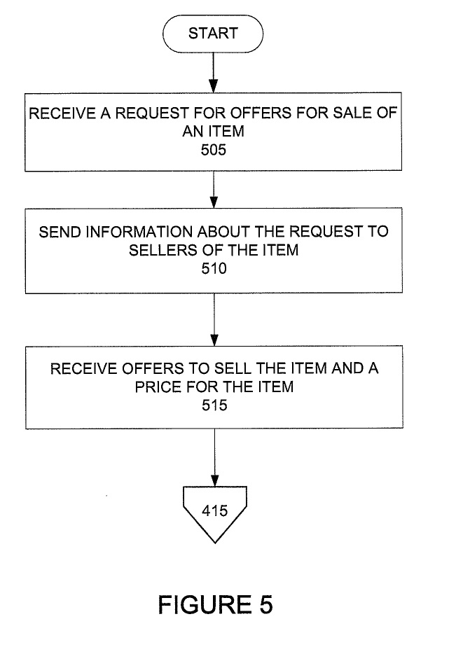

With reference now to FIG. 5, an illustration of a flowchart of a process for receiving offers for the sale of an item in a process for providing competitive marketplace is depicted in accordance with an illustrative embodiment. The process illustrated in FIG. 5 may be implemented in server computer 104 via network 102 in FIG. 1. The process also may be implemented by marketplace management program 230 in data processing system 205 in FIG. 2.

The process begins by receiving a request for offers for sale of an item (block 505). The process illustrated in FIG. 5 may be implemented in connection with the process illustrated in FIG. 4. For example, in block 405 the request may a request for offers for sale of an item. The process then sends information about the request to sellers of the item (block 510). In block 510, the consumer's request may be sent to all sellers of the item via a seller's interface to marketplace management system 200 (e.g., via a webpage, email, text message). Thereafter, the process receives offers to sell the item and a price for the item (block 515). The process then proceeds to block 415 in FIG. 4 to ranks item according to price and continues with the process for providing a competitive marketplace over a network.

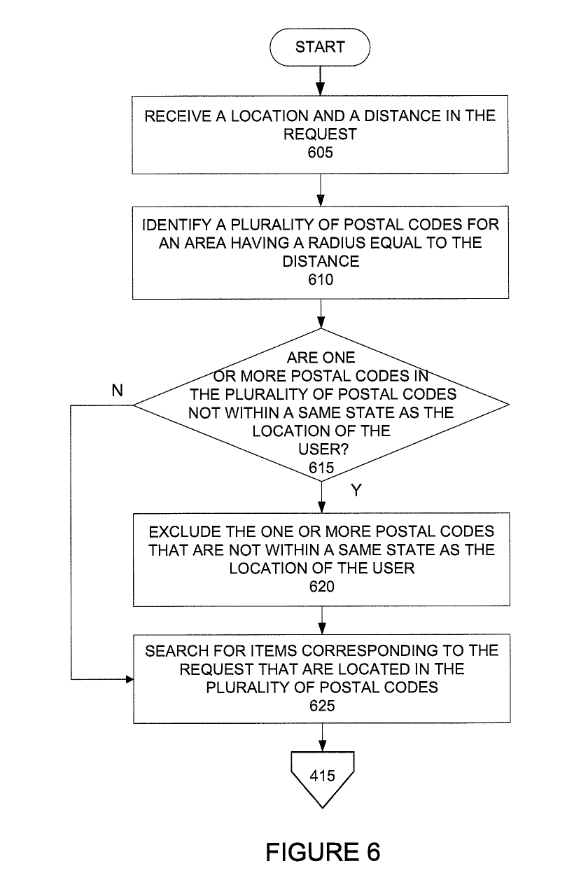

With reference now to FIG. 6, an illustration of a flowchart of a process for searching for items according to postal code in a process for providing competitive marketplace is depicted in accordance with an illustrative embodiment. The process illustrated in FIG. 6 may be implemented in server computer 104 via network 102 in FIG. 1. The process also may be implemented by marketplace management program 230 in data processing system 205 in FIG. 2.

The process begins by receiving a location and a distance in the request (block 605). The process illustrated in FIG. 5 may be implemented in connection with the process illustrated in FIG. 4. For example, in block 405 the request may include search parameters for the item including the location the consumer wants to search for items in as well as a distance to that location. The process then identifies a plurality of postal codes for an area having a radius equal to the distance (block 610). In block 610, data processing system 205 may use a mathematical algorithm and search postal code database 225 to identify each postal code within the desired search area.

Thereafter, the process determines whether one or more postal codes in the plurality of postal codes are not within a same state as the location of the user (block 615). In block 615, the postal codes in postal code database 225 may be associated with the state the postal code is located in. If the process determines that all of the postal codes in the plurality of postal codes are within a same state as the location of the user, the process proceeds to block 625 discussed below.

If, however, the process determines that one or more postal codes in the plurality of postal codes are not within a same state as the location of the user, the process excludes the one or more postal codes that are not within a same state as the location of the user (block 620). The process then searches for items corresponding to the request that are located in the plurality of postal codes (block 625). In block 625 the search results are searched by postal code and distance, however, the search is limited to a single state. For example, a consumer may be able to receive a more competitive marketplace when dealers can compete with each other without crossing state lines. Block 625 is an example of one implementation of block 410. For example, the process illustrated in FIG. 4 may have search results confined to a single state as described in FIG. 6. The process then continues to block 415 in FIG. 4 and continues with the process for providing a competitive marketplace over a network.

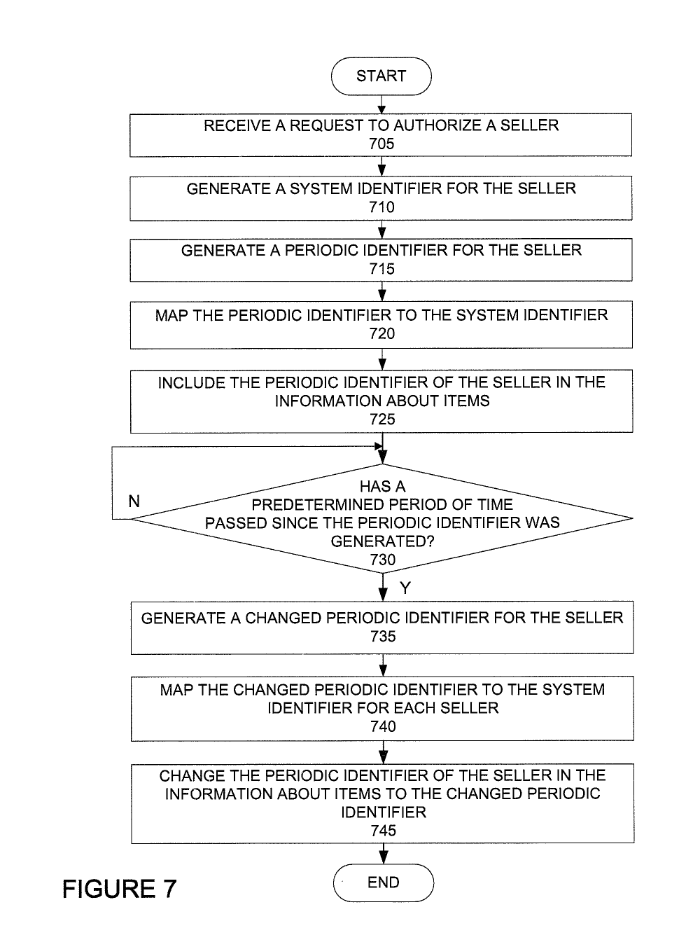

With reference now to FIG. 7, an illustration of a flowchart of a process for managing sellers and seller identification information in connection with providing competitive marketplace is depicted in accordance with an illustrative embodiment. The process illustrated in FIG. 7 may be implemented in server computer 104 via network 102 in FIG. 1. The process also may be implemented by marketplace management program 230 in data processing system 205 in FIG. 2.

The process begins by receiving a request to authorize a seller (block 705). In block 705, data processing system 205 may perform a seller account creation and login process. The process then generates a system identifier for the seller (block 710). In block 710, this system identifier is uniquely associated with that seller and remains confidential. Thereafter, the process generates a periodic identifier for the seller (block 715). In block 715, the periodic identifier is temporary and included with information about the items sold by the seller. The process then maps the periodic identifier to the system identifier (block 720). In block 720, the process keeps track of a current periodic identifier of the seller using the mapping. Thereafter, the process includes the periodic identifier of the seller in the information about items (block 725). In block 725, the periodic identifier may be included in a results set of items to be displayed to a user (e.g., block 430 in FIG. 4).

The process then determines whether a predetermined period of time has passed since the periodic identifier was generated (block 730). When the predetermined period of time has passed, the process generates a changed periodic identifier for the seller (block 735). In block 735, the period of time may be a predetermined amount of time or a randomly generated amount of time. The period of time may be based on a search session or on a transaction between a seller and consumer. Thereafter, the process maps the changed periodic identifier to the system identifier for each seller (block 740). The process then changes the periodic identifier of the seller in the information about items to the changed periodic identifier (block 745), with the process terminating thereafter. In block 745, the process periodically modifies the identifier of the seller displayed to consumers and other sellers. This adds a layer of difficulty in price collaboration and helps to provide a competitive market place.

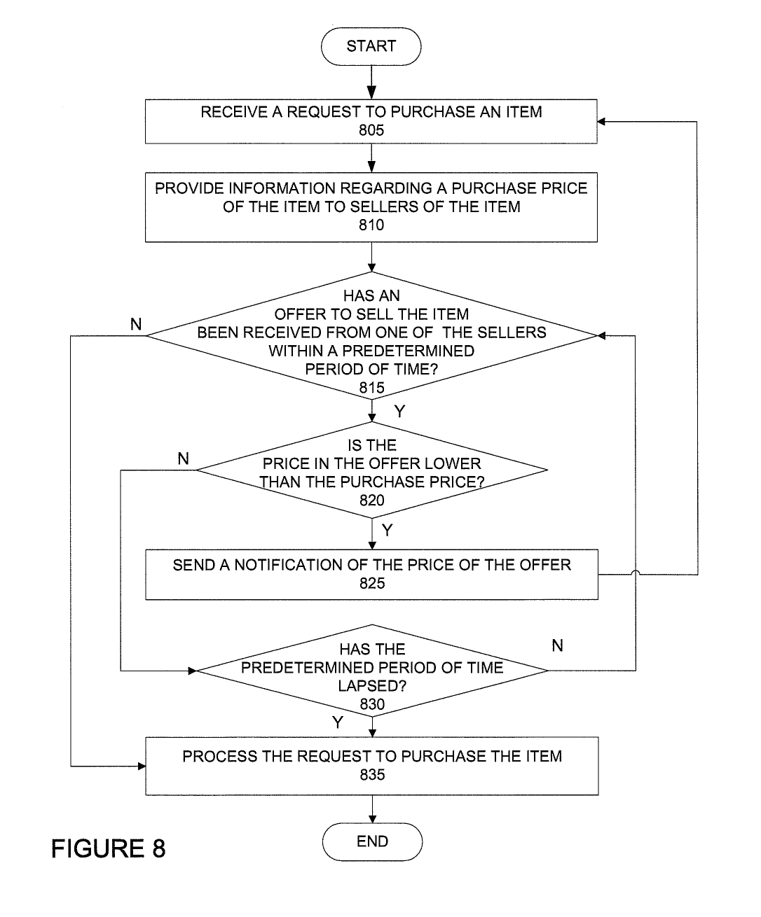

With reference now to FIG. 8, an illustration of a flowchart of a process for handling a request to purchase an item in connection with providing competitive marketplace is depicted in accordance with an illustrative embodiment. The process illustrated in FIG. 8 may be implemented in server computer 104 via network 102 in FIG. 1. The process also may be implemented by marketplace management program 230 in data processing system 205 in FIG. 2.

The process begins by receiving a request to purchase an item (block 805). The process then provides information regarding a purchase price of the item to sellers of the item (block 810). In block 810, the process allows other sellers of the item the opportunity to match or lower the price of the requested item. Thereafter, the process determines whether an offer to sell the item has been received from one of the sellers within a predetermined period of time (block 815). If the process determines that an offer to sell the item has not been received from one of the sellers within a predetermined period of time, the process proceeds to block 835 discussed below.

If, however, the process determines that an offer to sell the item has been received from one of the sellers within a predetermined period of time, the process determines whether the price in the offer is lower than the purchase price (block 820). If the process determines that the price in the offer is lower than the purchase price, the process sends a notification of the price of the offer (block 825). In block 825, the notification is sent to the consumer and the process returns to block 805 waits for the consumer to accept or reject the lower priced offer. If the consumer accepts the lower priced offer, the process may repeat with other sellers offered the opportunity to match or lower their price. If the consumer rejects the lower priced offer, the process may proceed to block 815 and waits to determine another offer is received within the predetermined period of time

If, however, at block 820, the process determines that the price in the offer is not lower than the purchase price, the process determines whether the predetermined period of time has lapsed (block 830). In block 830, the predetermined period of time may be set by marketplace management system 200 (e.g., a day or a week) or selected by a consumer based on how quickly they wish to receive the item. If the process determines that the predetermined period of time has not lapsed, the process returns to block 815 and determines whether an offer to sell the item has been received from one of the sellers within the predetermined period of time. If, however, the process determines that the predetermined period of time has lapsed, the process processes the request to purchase the item (block 835), with the process terminating thereafter.

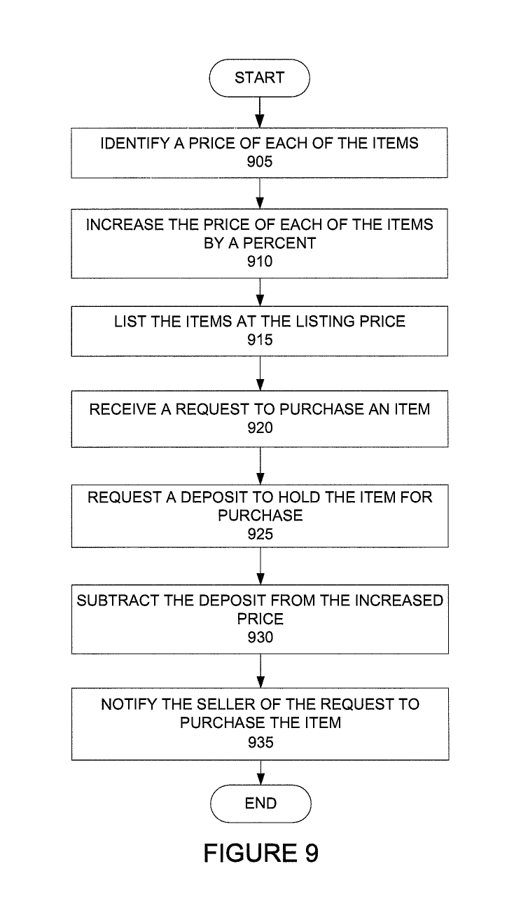

With reference now to FIG. 9, an illustration of a flowchart of a process for listing items at a price including a deposit in connection with providing competitive marketplace is depicted in accordance with an illustrative embodiment. The process illustrated in FIG. 9 may be implemented in server computer 104 via network 102 in FIG. 1. The process also may be implemented by marketplace management program 230 in data processing system 205 in FIG. 2.

The process begins by identifying a price of each of the items (block 905). The process illustrated in FIG. 9 may be implemented in connection with the process illustrated in FIG. 4. For example, in block 905 the process may identify the price of items corresponding to the request identified in block 410 in FIG. 4. The process then increases the price of each of the items by a percent (or amount) (block 910). In block 910, the increased price is for a deposit where the deposit plus the seller's price forms a listing price for each of the plurality of items. Thereafter, the process lists the items at the listing price (block 915).

The process then receives a request to purchase an item (block 920). When the process then receives a request to purchase an item, the process requests a deposit to hold the item for purchase (block 925). The process then subtracts the deposit from the increased price (block 930). In block 930, when the deposit is receive the contact information of the seller is then revealed to the consumer. Additionally, the process may perform a search to check that the item is still available at the requested price. Thereafter, the process notifies the seller of the request to purchase the item (block 935), with the process terminating thereafter. In block 935, the consumer can purchase the product from the seller at the sellers asked listing price.

The flowchart and block diagrams in the Figures illustrate the architecture, functionality, and operation of possible implementations of systems, methods and computer program products according to various illustrative embodiments. In this regard, each block in the flowchart or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams.

In some embodiments, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

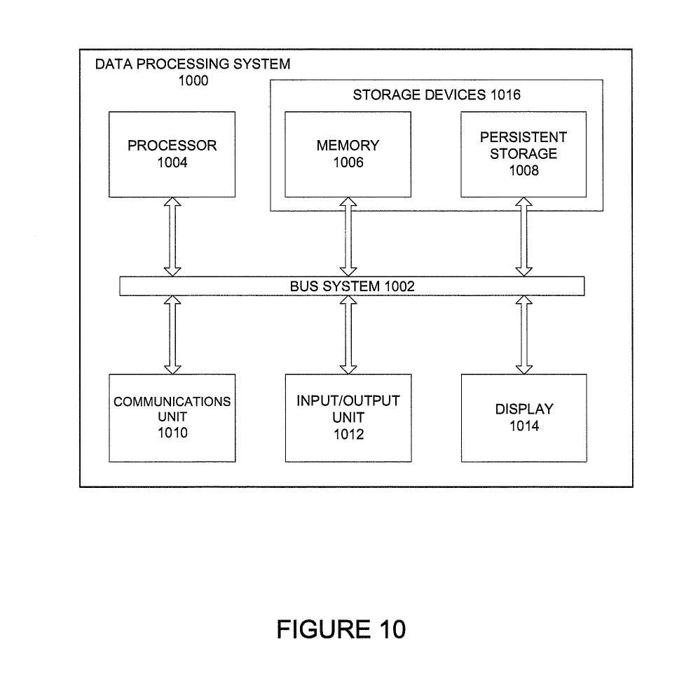

FIG. 10 illustrates an example data processing system 1000 in accordance with this disclosure. In this example, the data processing system 1000 includes a bus system 1002, which provides communications between a processor 1004, a memory 1006, a persistent storage 1008, a communications unit 1010, an input/output (I/O) unit 1012, and a display 1014. In these illustrative examples, data processing system 1000 is an example of one implementation of server computer 104 and client devices 108-118 in FIG. 1. Data processing system 1000 is also one example of data processing system 205 in FIG. 2.

Processor 1004 process instructions for software that may be loaded into memory 1006. Processor 1004 may be a number of processors, a multi-processor core, or some other type of processor, depending on the particular implementation. Further, processor 1004 may be implemented using a number of heterogeneous processor systems in which a main processor is present with secondary processors on a single chip. As another illustrative example, processor 1004 may be a symmetric multi-processor system containing multiple processors of the same type.

Memory 1006 and persistent storage 1008 are examples of storage devices 1016. A storage device is any piece of hardware that is capable of storing information, such as, for example, without limitation, data, program code in functional form, and/or other suitable information either on a temporary basis and/or a permanent basis. Memory 1006, in these examples, may be, for example, a random access memory or any other suitable volatile or non-volatile storage device. For example, persistent storage 1008 may contain one or more components or devices. For example, persistent storage 1008 may be a hard drive, a flash memory, an optical disk, or some combination of the above. The media used by persistent storage 1008 also may be removable. For example, a removable hard drive may be used for persistent storage 1008.

Communications unit 1010 provides for communications with other data processing systems or devices. In these examples, communications unit 1010 is a network interface card. Communications unit 1010 may provide communications through the use of either or both physical and wireless communications links.

Input/output unit 1012 allows for input and output of data with other devices that may be connected to data processing system 1000. For example, input/output unit 1012 may provide a connection for user input through a keyboard, a mouse, and/or some other suitable input device. Further, input/output unit 1012 may send output to a printer. Display 1014 provides a mechanism to display information to a user.

Program code for an operating system, applications, or other programs may be located in storage devices 1016, which are in communication with the processor 1004 through the bus system 1002. In some embodiments, the program code is in a functional form on the persistent storage 1008. These instructions may be loaded into memory 1006 for processing by processor 1004. The processes of the different embodiments may be performed by processor 1004 using computer implemented instructions, which may be located in memory 1006. For example, processor 1004 may perform processes for one or more of the modules and/or devices described above.

In some embodiments, various functions described above are implemented or supported by a computer program product that is formed from computer readable program code and that is embodied in a computer readable medium. Program code for the computer program product may be located in a functional form on computer readable storage device that is selectively removable and may be loaded onto or transferred to data processing system 1000 for processing by processor 1004. In some illustrative embodiments, the program code may be downloaded over a network to persistent storage 1008 from another device or data processing system for use within data processing system 1000. For instance, program code stored in a computer readable storage medium in a server data processing system may be downloaded over a network from the server to data processing system 1000. The data processing system providing program code 1018 may be a server computer, a client computer, or some other device capable of storing and transmitting program code 1018.

As will be appreciated by one skilled in the art, aspects of the present disclosure may take the form of a computer program product embodied in one or more computer readable storage medium(s) having program code embodied thereon. A computer readable storage medium may be, for example, without limitation, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. The program code may also be loaded for execution by a processor to provide processes for implementing the functions or operations described in the present disclosure.

The different illustrative embodiments of the present disclosure provide a competitive online marketplace with the implementation of bidding seller against seller is to have bids displayed on the website by page ranking or positioning. Consumers can utilize embodiments of the present disclosure to quickly find the lowest priced offer or most competitive offer instead of searching multiple results within one site, or multiple sites for the same item. The different illustrative embodiments of the present disclosure save the consumer time and money and allow the sellers the opportunity to hedge their inventory or financial forecast in coloration with their strategy and current or future economic forecast. In addition the creation of competitive online marketplace in accordance with the illustrative embodiments of the present disclosure reduce the chance for sellers to directly profit from deposits due to the fact that a third party verifies the seller.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of”, when used with a list of items, means that different combinations of one or more of the listed items may be used, and only one item in the list may be needed. For example, “at least one of item A, item B, and item C” may include, without limitation, item A or item A and item B.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a competitive marketplace via a network, the method comprising:
responsive to receiving a request for information about an item from a first data processing system, identifying, by a second data processing system, a plurality of items corresponding to the request;
ranking the plurality of items according to price to form a ranking of the plurality of items;
sending information about the plurality of items including the ranking to the first data processing system for display on a display associated with the first data processing system, wherein, according to the ranking, items with a lower price are displayed more prominently on the display than items with a higher price; and
providing information regarding the ranking of at least one item in the plurality items to a seller of the at least one item.

2. The method of claim 1 further comprising:
responsive to identifying a change in price of at least one of the plurality of items, re-ranking at least two of the plurality of items according to the change in price to form a re-ranking; and
sending, in real-time as the change is identified, information including the re-ranking to the first data processing system for re-ordering display of the at least two of the plurality of items according to the re-ranking.

3. The method of claim 1, wherein providing information regarding the ranking of the at least one item to the seller of the at least one item comprises:
providing information about one or more items in the plurality items that have a price that is lower than the at least one item of the seller including the price of the one or more items to the seller.

4. The method of claim 1 further comprising:
generating an identifier of each seller of the plurality of items; and
periodically modifying the identifier of each seller, wherein the information provided to the seller about one or more items in the plurality items that have a price that is lower than the at least one of the plurality items of the seller includes the identifier for each seller of the one or more items and does not include contact information for the seller.

5. The method of claim 1, wherein identifying the plurality of items corresponding to the request comprises:
sending information about the request to a plurality of sellers of the item; and
receiving offers to sell the item and a price for the item from one or more of the plurality of sellers.

6. The method of claim 1, wherein identifying the plurality of items corresponding to the request comprises:
identifying a plurality of postal codes for an area having a radius equal to a distance included in the request, wherein the distance is a distance from a location of a user associated with the first data processing system; and
searching for items corresponding to the request that are located at an address in the plurality of postal codes.

7. The method of claim 6 further comprising:
determining whether one or more postal codes in the plurality of postal codes are not within a same state as the location of the user; and
excluding the one or more postal codes that are not within a same state as the location of the user from the plurality of postal codes that the items corresponding to the request are searched.

8. The method of claim 1 further comprising:
responsive to receiving a request to purchase a first item in the plurality of items, providing information regarding a purchase price of the first item to one or more sellers of the plurality of items;
waiting a period of time before finalizing the purchase the first item;
responsive to receiving an offer from one of the one or more sellers to sell a second item in the plurality of items at a price that is lower than the purchase price of the first item, determining whether the offer was received within the period of time; and
responsive to receiving the offer within the period of time, sending a notification of the price of the offer to sell the second item.

9. The method of claim 1 further comprising:
responsive to identifying the plurality of items corresponding to the request, identifying a price of each of the plurality of items; and
increasing the price of each of the plurality of items by a percent for a deposit to form a listing price for each of the plurality of items,
wherein sending information about the plurality of items including the ranking to the first data processing system for display on the display comprises:
sending information about the plurality of items including the listing price for each of the plurality of items, wherein when one of the plurality of items is purchased the deposit is subtracted from the listing price.

10. The method of claim 1, wherein the item requested is a vehicle and the request includes a set of parameters for the vehicle.

11. A data processing system comprising one or more processors, one or more computer-readable memories, one or more computer-readable storage devices and program code stored on the one or more storage devices for execution by the one or more processors via the one or more memories that, when executed by the one or more processors, perform the method of claim 1.

12. A computer program product comprising one or more computer-readable, tangible storage devices and program code stored on the one or more storage devices that, when executed by one or more processors, performs the method of claim 1.

13. A data processing system configured to provide a competitive marketplace via a network, the data processing system comprising:
one or more storage devices configured to store program code; and
one or more processors configured to execute the program code to:
identify a plurality of items corresponding to a request for information about an item in response to receipt of the request from another data processing system;
rank the plurality of items according to price to form a ranking of the plurality of items;
send information about the plurality of items including the ranking to the other data processing system for display on a display associated with the other data processing system, wherein, according to the ranking, items with a lower price are displayed more prominently on the display than items with a higher price; and
provide information regarding the ranking of at least one item in the plurality items to a seller of the at least one item.

14. The data processing system of claim 13, wherein the one or more processors are further configured to execute the program code to:
re-rank at least two of the plurality of items according to a change in price to form a re-ranking in response to identifying a change in price of at least one of the plurality of items; and
send, in real-time as the change is identified, information including the re-ranking to the first data processing system for re-ordering display of the at least two of the plurality of items according to the re-ranking.

15. The data processing system of claim 13, wherein to provide information regarding the ranking of the at least one item to the seller of the at least one item, the one or more processors are further configured to execute the program code to:
provide information about one or more items in the plurality items that have a price that is lower than the at least one item of the seller including the price of the one or more items to the seller.

16. The data processing system of claim 13, wherein the one or more processors are further configured to execute the program code to:
generate an identifier of each seller of the plurality of items; and
periodically modify the identifier of each seller, wherein the information provided to the seller about one or more items in the plurality items that have a price that is lower than the at least one of the plurality items of the seller includes the identifier for each seller of the one or more items.

17. The data processing system of claim 13, wherein to identify the plurality of items corresponding to the request, the one or more processors are further configured to execute the program code to:
identify a plurality of postal codes for an area having a radius equal to a distance included in the request, wherein the distance is a distance from a location of a user associated with the other data processing system; and
search for items corresponding to the request that are located at an address in the plurality of postal codes.

18. The data processing system of claim 17, wherein the one or more processors are further configured to execute the program code to:
determine whether one or more postal codes in the plurality of postal codes are not within a same state as the location of the user; and
exclude the one or more postal codes that are not within a same state as the location of the user from the plurality of postal codes that the items corresponding to the request are searched.

19. A method for providing a competitive marketplace via a network, the method comprising:
responsive to receiving a request for information about a vehicle from a first data processing system, identifying, by a second data processing system, a plurality of postal codes for an area having a radius equal to a distance included in the request, wherein the distance is a distance from a location of a user associated with the first data processing system;
determining whether one or more postal codes in the plurality of postal codes are not within a same state as the location of the user;
responsive to determining that one or more postal codes are not within a same state as the location of the user, excluding the one or more postal codes from the plurality of postal codes to form a reduced set of postal codes;
identifying a plurality of vehicles corresponding to the request that are located at an address in the reduced set of postal codes;
ranking the plurality of vehicles according to price to form a ranking;
sending information about the plurality of vehicles including the ranking to the first data processing system for display on a display associated with the first data processing system, wherein, according to the ranking, vehicles with a lower price are displayed more prominently on the display than vehicles with a higher price; and
providing, to a seller of one vehicle in the plurality of vehicles, information about one or more other vehicles in the plurality vehicles that have a price that is lower than the one vehicle of the seller including the price of the one or more other vehicles.

20. The method of claim 19 further comprising:
responsive to identifying a change in price of at least one of the plurality of vehicles, re-ranking at least two of the plurality of vehicles according to the change in price to form a re-ranking; and
sending, in real-time as the change is identified, information including the re-ranking to the first data processing system for re-ordering display of the at least two of the plurality of vehicles according to the re-ranking.
